(19) United States
(12) Patent Application Publication
(10) Pub. No.: US 2010/0021121 A1
(43) Pub. Date: Jan. 28, 2010

(54) METHOD FOR FORMING A COUPLING UNIT ON A LONG COMPOSITE FIBRE SECTION

(76) Inventor: Thomas Decker, Lauterach (AT)

Correspondence Address: WENDEROTH, LIND & PONACK, L.L.P., 1030 15th Street, N.W.,, Suite 400 East, Washington, DC, 20005-1503, US

(21) Appl. No.: 12/219,424

(22) Filed: Jul. 22, 2008

(51) Int. Cl. G02B 6/00

(52) U.S. Cl. 385/136

(57) ABSTRACT

In a method for the formation of an anchorage transmitting a longitudinal force, of an elongated composite fiber component, in particular in the form of a tension or pressure bar, which includes a thermoplastic matrix material and fibers embedded therein, on a force application element, which includes a cavity that accepts the composite fiber component over a connection section of its longitudinal extent, between the composite fiber component and the force application element a form-locking connection, acting in the longitudinal direction of the composite fiber component, is formed. For the formation of the form-locking connection the geometry of the composite fiber component, while its temperature is above the glass transition temperature of the matrix material of the composite fiber component in the connection section, is changed through a press force acting onto the external surface of the composite fiber component such that the cross sectional area of the connection section over its longitudinal extent is changed in terms of its areal enclosure. The diameter of the composite fiber component, with respect to at least one certain direction located at right angles to the longitudinal direction of the composite fiber component, is changed over the longitudinal extent of the connection section.

### BACKGROUND OF THE INVENTION

a) Field of the Invention

The invention relates to a method for the formation of an anchorage transmitting a longitudinal force, of an elongated composite fiber component, in particular in the form of a tension or pressure bar, which component comprises a thermoplastic matrix material and fibers embedded therein, on a force application element including a cavity, which cavity accepts the composite fiber component over a connection section of its longitudinal extent, wherein between the composite fiber component and the force application element a form-locking connection is formed acting in the longitudinal direction of the composite fiber component. The invention furthermore relates to an anchorage for the transmission of a longitudinal force between an elongated composite fiber component and a force application element.

b) Description of Related Prior Art

Due to the problematic force application into elongated composite fiber components, for example composite fiber bars, steel bars are most frequently utilized as tension or pressure bars, although composite fiber bars have a number of outstanding properties. They are inter alia distinguished by their low weight, corrosion resistance and electrically insulating properties. The strength and rigidity properties of composite fiber bars are excellent. However, one problem consists in applying tension and pressure forces into bar-form composite fiber components such that they are appropriate to the material and force flow involved.

For example, for this purpose the fabrication of composite fiber bars as continuous loops has been carried out, wherein the tension bar forms a loop about a bolt for the force application. Such a fabrication of continuous loops of composite fiber material, however, involves high complexity, inter alia for each tension bar extent a tool of suitable length is required.

Disclosed are further, for example in DE 39 42 535 A1, material-closure connections in the form of adhesion connection and cast anchorages for fastening tension bars in a force application element. For such adhesions and grouted anchorages, however, an adequate adhesion area must be available which is lacking in some application cases. The necessary adhesion length for a composite fiber rod having a diameter of 12 mm is, for example, 500 to 700 mm.

Further, force-closure connections between the end of a tension bar and a force application element have been described. In the connection disclosed in EP 0 001 235 A1 the force application element is comprised of an inner conical part set into an outer part with a corresponding inner contour and which can be clamped by this with the tension bar. Of disadvantage in force-closure connections are the uncertainties due to possibly changing frictional conditions and prestress and possible vibrational or oscillatory friction wear.

An anchorage of the above described type is also known and disclosed inter alia in DE 10 2004 038 082 A1 not prior published and of earlier priority. Herein, together with the force application element, a spreading body having a point is axially guided onto the end of the tension bar. The spreading body is centrally pressed into the tension bar which had been brought to softening temperature, wherein the radially displaced material of the tension bar is diverted into a space between the outer contour of the spreading body and the inner contour of the force application element and the diverted material, further, is brought together behind the spreading body in order to enclose the spreading body in the end of the tension bar. In this way, a form closure, acting in the longitudinal direction of the composite fiber component, is formed between the composite fiber component and the force application element, via which tensile forces can be absorbed. A disadvantage is inter alia the complexity of the method. Through the very strong deformation of the composite fiber material in the region of the connection section, uncertainties with respect to the static and dynamic properties of the anchored composite fiber component can also result in this region and this method is not suitable for all types of composite fiber components.

In the anchorage disclosed in GB 2 418 713 a mandrel is introduced axially into the end section of the composite fiber component and a sleeve is placed about this end section of the composite fiber component. The mandrel or the sleeve have a non-cylindrical surface and, after heating the material of the composite fiber component, the mandrel is expanded or the sleeve is contracted in order to secure the end section of the composite fiber component in place between these two parts.

GB 816 926 A describes a connection between a composite fiber component not according to the genus, which comprises a duroplastic matrix material with a sleeve encompassing the composite fiber component on the outside. The sleeve is pressed onto the composite fiber component, whereby a force-closure connection between the sleeve and the composite fiber component is formed.

A force-closure connection of a cable which comprises fibers, for example, of a synthetic material encompassed by a synthetic material shell, with a sleeve is disclosed in GB 2 150 164 A.

GB 2 105 831 A discloses a fiber-reinforced synthetic rod which is connected with a sleeve-form force application element. The force application element is here pressed radially over the circumference onto the synthetic rod in order to establish the connection. The rod is herein compressed in its outer circumference.

U.S. Pat. No. 3,994,607 A describes a longitudinal connection for fiber-reinforced synthetic material wires, wherein a sleeve-form force application element into which the particular wire is slid, is pressed onto the particular wire.

### SUMMARY OF THE INVENTION

The invention addresses the problem of providing a method of the above described type which is simple by implementation, by which a secure and reliable anchorage of an elongated composite fiber component on a force application element can be attained, or to provide a secure and reliable such anchorage.

According to the invention this is attained through a method for the formation of an anchorage transmitting a longitudinal force, of an elongated composite fiber component, which includes a thermoplastic matrix material and fibers embedded therein, on a force application element which includes a cavity, which cavity accepts the composite fiber component over a connection section of its longitudinal extent. For the formation of a form-locking connection, acting in the longitudinal direction of the composite fiber component, between the composite fiber component and the force application element the geometry of the composite fiber component, while its temperature is above the glass transition temperature of the matrix material of the composite fiber component, in the connection section is changed through a press force acting onto the external surface of the composite fiber component in such a way that the cross sectional area of the connection section over its longitudinal extent is changed in terms of its areal enclosure. The diameter, with respect to at least one certain direction located at right angles to the longitudinal direction of the composite fiber component, of the composite fiber component changes over the longitudinal extent of the connection section.

According to the invention an anchorage is provided by which a longitudinal force can be transmitted between an elongated composite fiber component, which includes a thermoplastic matrix material and fibers embedded therein, and a force application element, which includes a cavity that accepts the composite fiber component over a connection section of its longitudinal extent. Between the composite fiber component and the force application element a form-locking connection is formed acting in the longitudinal direction of the composite fiber component and wherein the connection section, with respect to at least one direction oriented at right angles to the longitudinal direction of the composite fiber component, has at least one constriction in the diameter of the composite fiber component.

In the method according to the invention, consequently, a geometry change of the composite fiber component establishing the form lock is generated through the press force acting from the outside onto the composite fiber component without, as is the case in prior art, the form lock being formed by means of a third component, such as adhesive means, grouting compound, displacement body, etc. The form lock is formed directly between the changed geometry of the composite fiber component in its connection section and the geometry of the force application element. In the change of the geometry of the connection section a change of the areal enclosure of the cross sectional area of the connection section occurs over its longitudinal extent. This means that through the acting press force thermoplastic matrix material, whose temperature is above its glass transition temperature, is displaced from a region in which the press force acts. Thus a flow of thermoplastic matrix material occurs in the longitudinal direction of the composite fiber component.

The matrix material displaced from the region of the acting press force can lead to a thickening (cross section enlargement) at another site of the composite fiber component and/or can, at least partially, exude from a front-side end of the composite fiber component.

With the change of the cross sectional area of the connection section a change of the diameter of the composite fiber component occurs over the longitudinal extent of the connection section, at least with respect to at least one certain direction oriented at right angles to the longitudinal direction of the composite fiber component.

In one embodiment of the invention the press force is exerted by means of a pressing tool directly onto the external surface of the composite fiber component (while the temperature of the composite fiber component in the connection section is above the glass transition temperature). After the geometry change has been carried out in this manner of the composite fiber component in the connection section and after the composite fiber component has cooled, the force application element is attached on the connection section, which in this case comprises at least two separate parts connectable with one another, which, for example, are each formed in the shape of a half-shell.

In another embodiment of the invention a pressing tool acts onto the force application element already placed onto the connection section of the composite fiber component. The press force is transmitted via the force application element onto the composite fiber component and the force application element, simultaneously with the composite fiber component, is deformed for the purpose of forming the form lock acting in the longitudinal direction of the composite fiber component.

In an anchorage established through a method according to the invention, the fibers of the composite fiber component can in advantageous manner be maintained, and specifically in a favorable force flow direction. The press force exerted in the formation of the anchorage acts advantageously transversely to the longitudinal direction of the composite fiber component onto its shell surface.

### BRIEF DESCRIPTION OF THE DRAWINGS

Further advantages and details of the invention will be explained in the following in conjunction with the attached drawings.

In the drawings:

FIG. 1 is a schematic illustration of a method step for the anchorage of the composite fiber component on the force application element according to an embodiment of the invention, in longitudinal central section,

FIG. 2 shows the anchorage completed according to this embodiment of the invention in longitudinal central section,

FIG. 3 is a section along line A-A of FIG. 2,

FIG. 4 is a section along line B-B of FIG. 2,

FIG. 5 is a section along line C-C of FIG. 2,

FIG. 6 shows an anchorage according to a minimally modified embodiment,

FIG. 7 is a schematic illustration of a method step of a method according to The invention according to a further embodiment, in longitudinal central section,

FIG. 8 is a longitudinal central section of the completed anchorage according to a further embodiment,

FIG. 9 to FIG. 12 are sections along the lines D-D, E-E, F-F and G-G of FIG. 8.

### DETAILED DESCRIPTION OF THE PREFERRED EMBODIMENTS

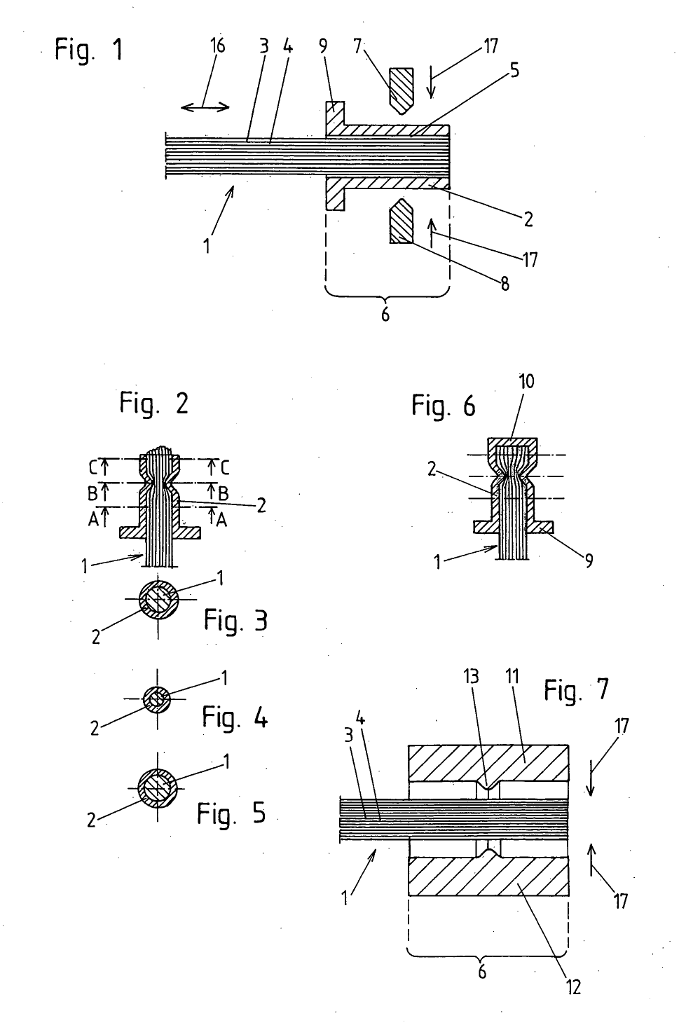

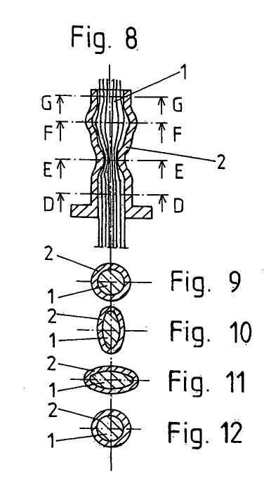

A first embodiment of the invention will be explained in the following in conjunction with FIG. 1 to 5. Through a method according to the invention an elongated or bar-form composite fiber component 1 is to be anchored on a force application element 2 such that a longitudinal force can be transmitted, acting at least into one of the longitudinal directions of the composite fiber component 1, which directions are indicated in FIG. 1 by the double arrow 16.

The composite fiber component 1, which is formed in particular as a tension or pressure bar, can have various cross sectional geometries. The cross sectional area and geometry is constant before carrying out the method according to the invention, for example over the entire length of the composite fiber component. In the embodiment according to FIG. 1 to 5 the composite fiber component, before the method according to the invention has been carried out, has at least over a connection section 6, a constant circular cross section. Other, for example rectangular cross sectional, profiles are also conceivable and feasible.

The composite fiber component 1 includes fibers 3, which are embedded in a matrix material 4 formed of a thermoplastic synthetic material. The fibers 3 can be formed as continuous endless fibers or as long fibers (preferably of a length of more than 10 mm) and are distributed (regularly or irregularly) over the cross section of the composite fiber component. The fibers 3 can be oriented unidirectionally wherein they extend parallel to the longitudinal direction 16 (or longitudinal axis) of the composite fiber component 1, or they have a multidirectional fiber orientation, for example in the form of a twisted braiding, meshing or knitting. Such composite fiber components 1 are known and are produced by extrusion or pultrusion in a continuous production process. The fibers 3 can be formed of different materials, for example, in the form of carbon, glass, mineral or metal fibers or mixtures thereof.

In the embodiment according to FIG. 1 to 5 the force application element 2 formed in the shape of a sleeve is slid onto the composite fiber component 1 in the axial direction of the same, such that the cavity (=the inner hollow volume) of the force application element 2 accepts the composite fiber component 1 over a connection section 6 of the same, wherein it encompasses the force application element 2 over the connection section 6 with minimal play. The composite fiber component 1 in the connection section 6 has herein still its original geometry, i.e. the connection section 6 is straight and coaxial with the remaining portion of the composite fiber component 1 and its cross sectional contour and cross sectional area are constant over its longitudinal extent.

For the formation of a form-lock connection, acting in the longitudinal direction of the composite fiber component 1, between the composite fiber component 1 and the force application element 2, the composite fiber component 1 is subsequently heated at least in the connection section 6 to a temperature at least above the glass transition temperature (Tg) of the matrix material 4, preferably to a temperature above the melting point of the matrix material 4. This heating of the composite fiber component 1 can take place, for example, by heating the force application element 2 by means of a heating device. The composite fiber component 1 could also have been heated to this temperature before the force application element 2 had been placed onto it. By heating the matrix material 4 to said temperature, it is softened such that it is flowable (at atmospheric pressure).

Onto the force application element 2 subsequently a press force is exerted from the outside by means of a pressing tool, which acts transversely, preferably at right angles, to the longitudinal direction 16 of the composite fiber component 1 onto the force application element 2. The pressing tool can comprise, for example, several pressing jaws 7, 8 adjoining one another in the circumferential direction, which are acted upon radially against the force application element 2. Through the press force 17, exerted onto the force application element 2, of the pressing tool, which is indicated in FIG. 1 by arrows, this element is deformed. In the depicted embodiment it is pressed circumferentially and radially inwardly in a central region of its longitudinal extent such that it is provided with a constriction.

Through the deformation of the force application element 2 press force 17 of the pressing tools is transmitted via the force application element 2 onto the composite fiber component 1 and, consequently, acts onto the outer surface of the composite fiber component 1. Thermoplastic matrix material 4, which has been softened through the heating, is thereby displaced out of the region in which the pressing jaws 7, 8 act. The geometry of the connection section 6, here in the central region of its longitudinal extent, thereby changes in such manner that at the site of the constriction of the force application element 2 a constriction of the composite fiber component 1 is formed. This constriction formed circumferentially or annularly is located in a region of the connection section 6, which is disposed between cylindrical regions of the connection section 6. The constrictions of the force application element 2 and of the composite fiber component 1 are in contact on one another and a form-locking connection, acting in the longitudinal direction of the composite fiber component 1, is formed.

The matrix material 4 displaced from the region of the constriction of the composite fiber component 1 leads to a thickening (cross section enlargement) at another site of the composite fiber component 1 and/or can at least partially exude from the front-side end of the composite fiber component 1, which adjoins the connection section 6 in the depicted embodiment, provided this end is not closed off by the force application element 2.

The force application element 2 can, as shown, have for example an outwardly projecting annular flange 9, via which it can be connected with another part, not depicted in the Figures, for example a load-bearing structure, in order to transmit forces.

In the previously described embodiment example the assumption was made that the attaching of the force application element 2 takes place after the production process of the composite fiber component 1 has been completed. However, it would also be conceivable and feasible to carry out the anchoring during the production of the composite fiber component, in particular during the extrusion or pultrusion, after it has exited the nozzle and consequently has received its original forming at least in the connection section 6 and a portion of the composite fiber component adjoining thereon and as long as the temperature of the matrix material 4 in the connection section 6 is still above the glass transition temperature, preferably above the melting point. A separate heating step could thereby be omitted in the implementation of the method according to the invention.

The force application element 2 depicted in FIG. 1 to 5 can, as shown, be anchored in the end region of the composite fiber component 1 or also in a central section of the composite fiber component 1.

The embodiment depicted in FIG. 6 differs from the previously described embodiment example only thereby that, while the force application element 2 is formed again in the shape of a sleeve, however, here it is provided with a bottom 10 closing the interior volume of the force application element 2 at one end. This force application element 2 can consequently only be attached at the end of the composite fiber component 1, i.e. the connection section 6 forms an end section of the composite fiber component 1.

Instead of exerting the press force onto the force application element 2, which is transmitted from it onto the outer surface of the composite fiber component 1, the press force 17 can also be exerted by a pressing tool directly onto the composite fiber component 1 in the region of its connection section 6, as is depicted schematically in FIG. 7. The pressing tool can, for example, comprise two pressing jaws 11, 12, which, in the state in which they are placed onto the composite fiber component 1, extend each over 180° of its circumference and in this way are formed in the shape of half-shells, wherein they have an inwardly projecting protuberance 13 in a central region of their longitudinal extent. After the composite fiber component 1 in the connection section 6 has been brought to a temperature above the glass transition temperature, which is preferably above the melting point, the pressing jaws 11, 12 are placed against the composite fiber component 1, whereby onto the external surface of the composite fiber component 1 a press force 17 is exerted and the geometry of the composite fiber component 1 in the region of its connection section 6 is changed. In the depicted embodiment example, a circumferential constriction is formed.

After the connection section has cooled, a force application element 2 is placed onto the connection section. In this embodiment example this element is implemented as a multipart element such that the parts can be applied radially, whereupon, in the state in which they are placed onto the connection section 6, they can be connected with one another, for example by means of screw-connections or by means of clamping rings.

The pressing jaws 11, 12 can extend over the length of the connection section 6, over a portion of this length or they can extend beyond this length.

Instead of subsequent deformation of the connection section 6 after the production of the composite fiber component 1, the geometry change by means of the pressing tool could again be carried out during the production of the composite fiber component 1 when the connection section 6 still has a sufficiently high temperature.

In comparison to the previously described embodiments, in the embodiment example depicted in FIG. 8 to 12 a greater portion of the reinforcement fibers is deflected from its original position or a stronger deflection of the fibers 4 occurs through the geometry change in the connection section 6. The originally circular cross section of the composite fiber component 1 is here changed in its form in the connection section 6, and specifically in the region of the section lines E-E and F-F oval cross sectional shapes are formed, whose longer axes are at right angles with respect to each other. The connection section 6 overall has a first and second cylindrically shaped region (at the two ends of the connection section 6) and a region located in between with a geometry changed in comparison. Herein in the region spaced in between, with respect to directions located at right angles to the longitudinal extent of the composite fiber component 1, constrictions of the diameter of the composite fiber component are formed. The sleeve-form force application element 2, originally circular in cross section, is deformed correspondingly. The deformation can again be carried out by a pressing tool comprising pressing jaws.

In the embodiments in which the force application element 2 is deformed together with the composite fiber component 1, it is comprised of a material which is, at least at increased temperatures, plastically deformable. The force application element 2 is preferably comprised of metal. The force application element 2 must be able to absorb the normal forces acting in terms of a spreading generated through the occurring tension or pressure forces.

The production of the geometry change in the connection section 6 and the connection with the force application element 2 can also take place directly on site at the end user.

For local reinforcement or for a better force application, in the connection section 6 additional fibers, textile sheeting, tubes, tapes, sleeves or the like can be inserted between the composite fiber component 1 and the force application element 2. To attain other effects, for example for damping, insulation, etc., films, tubes, textile sheeting, etc. of other materials, for example elastomers, can also be inserted.

Into the core of the composite fiber component can also be integrated a function element, for example an optical waveguide. The geometry change of the composite fiber component 1 in the connection section 6 herein takes place such that the core remains unimpaired. The function element can be, for example, a medium, information or energy transmitting element, for example a waveguide, water pipe, etc.

The composite fiber component can have a solid cross section in the connection section, i.e. not have a hollow volume. If the anchorage is to be carried out with a composite fiber component over a portion of its length, which comprises at least partially the connection section, or over one that is overall tubular, before the action of the press force into the region of the acting press force a core filling the hollow volume can be introduced. This core can subsequently be removed again.

The particular force application elements preferably only encompass the particular composite fiber component on its outside, thus have no portions located within the composite fiber component.

As is evident in the preceding description, the scope of the invention is not limited to the depicted embodiment examples but rather, with reference to the attached claims, should be determined with its full range of feasible equivalents. While the preceding description and the drawing represent the invention, it is obvious to a person of skill in the art that various modifications can be carried out therein without leaving the true spirit and scope of the invention.

### LEGEND TO THE REFERENCE NUMBERS

1 Composite fiber component
2 Force application element
3 Fiber
4 Matrix material
5 Cavity
6 Connection section
7 Pressing jaw
8 Pressing jaw
9 Annular flange
10 Bottom
11 Pressing jaw
12 Pressing jaw
13 Protuberance
16 Longitudinal direction
17 Press force

1. A method for the formation of an anchorage transmitting a longitudinal force, of
an elongated composite fiber component which includes a thermoplastic matrix material and fibers embedded therein, on a force application element which includes a cavity that accepts the composite fiber component over a connection section of its longitudinal extent, wherein for the formation of a form-locking connection acting in the longitudinal direction of the composite fiber component, between the composite fiber component and the force application element the geometry of the composite fiber component, while its temperature is above the glass transition temperature of the matrix material of the composite fiber component, is changed in the connection section through a press force acting onto the external surface of the composite fiber component such that the cross sectional area of the connection section is changed over its longitudinal extent in its areal enclosure, wherein the diameter, in at least one certain direction located at right angles to the longitudinal direction of the composite fiber component, of the composite fiber component is changed over the longitudinal extent of the connection section.

2. The method as claimed in claim 1, wherein the press force acts transversely to the longitudinal direction of the composite fiber component onto the latter.

3. The method as claimed in claim 1, wherein the press force is exerted through a pressing tool onto the force application element and via the force application element is transmitted onto the external surface of the composite fiber component.

4. The method as claimed in claim 3, wherein through the exerted press force the force application element is deformed simultaneously with the composite fiber components.

5. The method as claimed in claim 1, wherein the press force is exerted through a pressing tool directly onto the external surface of the composite fiber component.

6. The method as claimed in claim 5, wherein the force application element is formed of at least two separate parts which are placed onto the connection section, already provided with the geometry change, of the composite fiber component, and are fastened on such.

7. The method as claimed in claim 1, wherein the geometry change of the connection section of the composite fiber component is carried out during the production of the composite fiber component, which preferably takes place by extrusion or pultrusion, while the temperature of the connection section after its original forming is still above the glass transition temperature.

8. The method as claimed in claim 1, wherein before the exertion of the press force the composite fiber component at least in the connection section is heated to a temperature above the glass transition temperature.

9. The method as claimed in claim 1, wherein the temperature of the matrix material in the connection section during the geometry change of the connection section is above the melting temperature of the matrix material.

10. The method as claimed in claim 1, wherein the force application element is formed in the shape of a sleeve.

11. The method as claimed in claim 1, wherein the composite fiber component before the action of the press force has a constant cross sectional area and cross sectional geometry over the length of the connection section.

12. The method as claimed in claim 11, wherein the composite fiber component before the action of the press force has a constant cross sectional area and cross sectional geometry over its entire length.

13. The method as claimed in claim 1, wherein the composite fiber component is a tension or pressure bar.

14. An anchorage, by which a longitudinal force can be transmitted, between an elongated composite fiber component, which includes a thermoplastic matrix material and fibers embedded therein, and a force application element, which includes a cavity that accepts the composite fiber component over a connection section of its longitudinal extent, wherein between the composite fiber component and the force application element a form-locking connection, acting in the longitudinal direction of the composite fiber component, is formed and wherein the connection section, with respect to at least a direction located at right angles to the longitudinal direction of the composite fiber component, includes at least one constriction in the diameter of the composite fiber component.

15. The anchorage as claimed in claim 14, wherein the constriction in the diameter is formed annularly.

16. The anchorage as claimed in claim 14, wherein the constriction is located between first and second cylindrically formed regions of the connection section.

17. The anchorage as claimed in claim 14, wherein the cavity of the force application element comprises a decrement of its diameter which cooperates with the constriction of the composite fiber component.

18. The anchorage as claimed in claim 17, wherein the decrement of the diameter of the cavity is located between first and second cylindrically formed regions of the force application element.

19. The anchorage as claimed in claim 14, wherein the composite fiber component is a tension or pressure bar.
